(19) United States
(12) Patent Application Publication
(10) Pub. No.: US 2005/0194344 A1
(43) Pub. Date: Sep. 8, 2005

(54) Replacement bottle for fragrance dispensers

(75) Inventor: Andrew Heater, Tuxedo, NY (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Neptune Plastics Manufacturing Corporation

(21) Appl. No.: 11/073,129

(22) Filed: Mar. 4, 2005

Related U.S. Application Data
(63) Continuation-in-part of application No. 29/176,951, filed on Feb. 28, 2003, now Pat. No. D503621.

(51) Int. Cl. B67D 1/00; B65D 90/02

(52) U.S. Cl. 215/379

(57) ABSTRACT

A fragrance oil refill container is adapted to attach selectively to each of a plurality of fragrance dispensers by an arrangement including protuberant device on one side of the container for fitting into a opening in one of the extending lower wall portions of a first configured dispenser, thereby selectively enabling secure attachment of the container to the first dispenser; a cylindrical protuberance is located on the opposite side of the container for fitting into an arcuate groove portion of a second, differently configured dispenser, thereby selectively enabling secure attachment of the container to the second dispenser; and spaced grooves are provided on the opposite side of the container for spanning correspondingly spaced walls in a third, differently configured dispenser, thereby selectively enabling secure attachment of the container to the third dispenser.

This application is a continuation-in-part of application Ser. No. 29/176,951, filed Feb. 28, 2003, and the benefit of that filing is claimed under the provisions of 35 USC 120.

### BACKGROUND OF THE INVENTION

This invention relates to fragrance dispensers which utilize a fragrance or perfume oil bottle that must be suitably engaged and retained in operative relationship with the dispenser. Such a dispenser typically plugs into a suitable electrical outlet whereby the oil can be slightly heated before it is dispensed to the room or other area.

A fairly large variety of dispensers are available in the market place, and consumers are frequently confronted with the need to furnish a fresh supply of perfume oil or the like to their most recently acquired dispenser. However, the bottle-receiving portion of various dispensers vary in their design and construction while the original bottles sold with the dispensers have been specially designed to be received and engaged selectively within a particular dispenser. Therefore, it becomes a problem for a consumer when there is need for replenishment of the perfume oil to find a precisely designed replacement bottle suitable for his particular fragrance dispenser.

### SUMMARY OF THE INVENTION

Accordingly, the present invention provides an answer to the problem of replacement by including a plurality of means in the form of disparate features on a single bottle so as to enable the consumer to replace by such unique bottle a quantity of perfume oil for supply to a number of differently designed and structured dispensers. This is realized by economically provided features on a universal replacement or refill bottle that make for ready attachment of that bottle to two or more different forms of fragrance dispensers.

### DESCRIPTION OF DRAWINGS

FIG. 1 is a right side elevational view of the fragrance dispenser bottle;

FIG. 2 is a top plan view thereof;

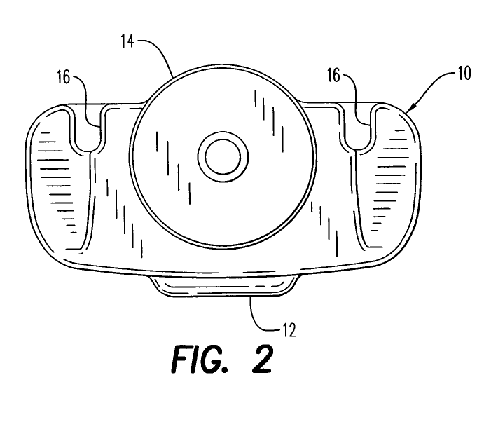

FIG. 3 is a bottom plan view thereof;

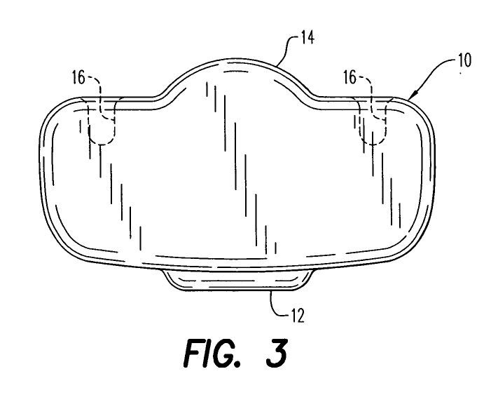

FIG. 4 is a front elevational view thereof;

FIG. 5 is a rear elevational view thereof;

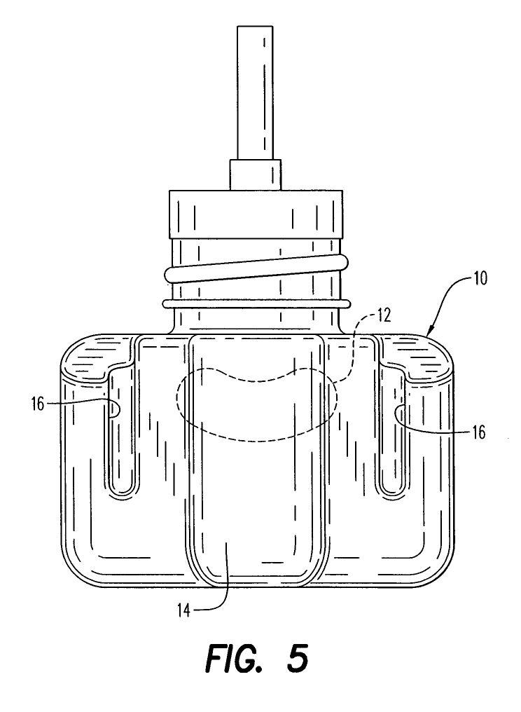

FIG. 6 is a right side perspective view of the fragrance dispenser bottle;

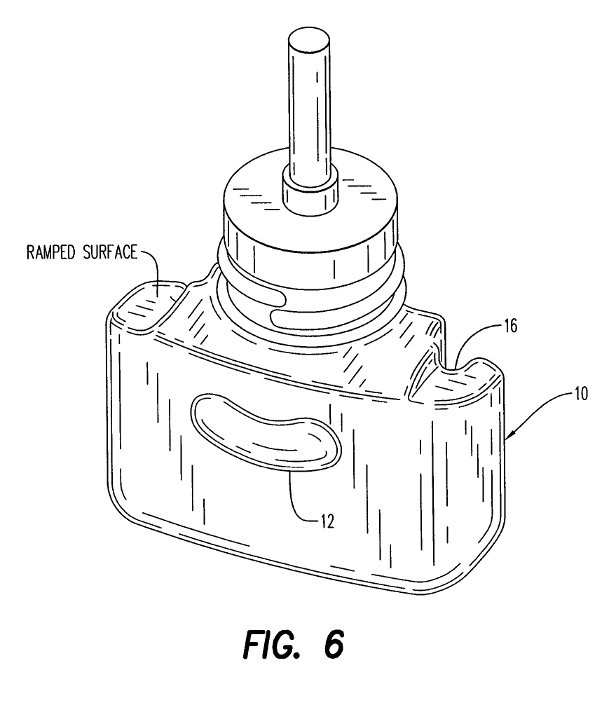

FIG. 7 is a combined view of a fragrance dispenser and a dispenser bottle adapted to be received and held by the particular dispenser;

FIG. 8 is a combined view of another fragrance dispenser and the same dispenser bottle, as in FIG. 7, adapted to be received and held by the particular dispenser; and

FIG. 9 is a combined view of a third fragrance dispenser and the same dispenser bottle, as in FIG. 7, also adapted to engage the particular dispenser.

The foregoing and still further objects and advantages of the present invention will be more apparent from the following detailed explanation of the preferred embodiments of the invention in connection with the accompanying drawing.

### DESCRIPTION OF PREFERRED EMBODIMENT

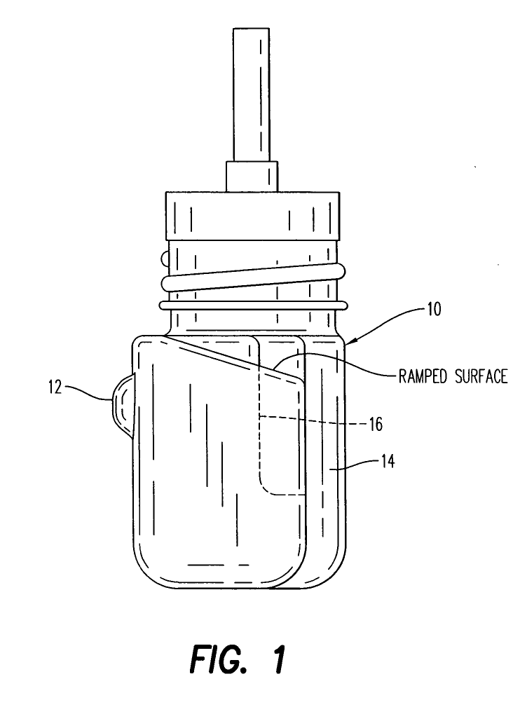

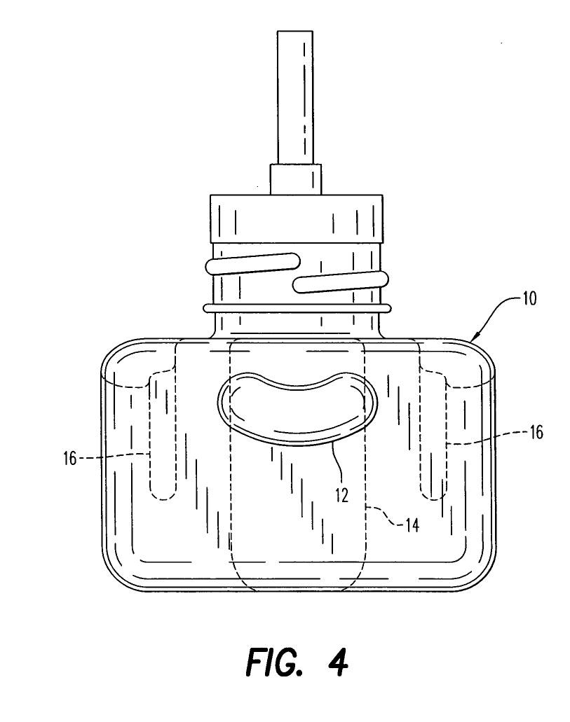

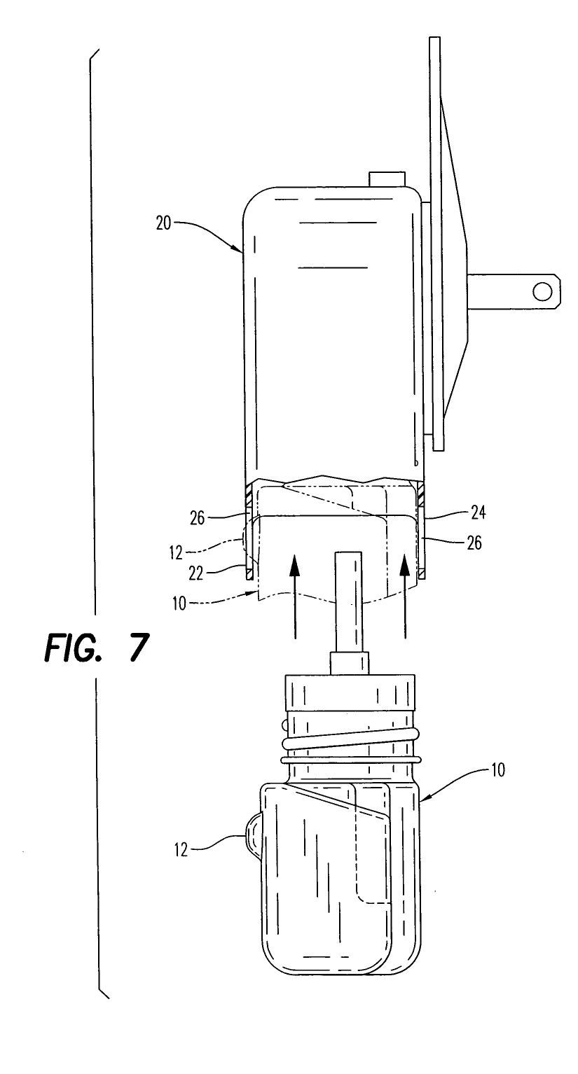

Referring now to FIG. 1, the right elevational view of the replacement bottle 10, which is provided with a protuberant or bumped-out portion 12 in the shape of a banana or the like, seen also in the front view of FIG. 4. This constitutes the first feature of the present invention that adapts the replacement bottle 10 to be received by a first dispenser 20 as seen in FIG. 7. In this figure it will be appreciated that the dispenser 20 has two pendant lower portions, in the form of spaced wall members 22 and 24, each having a crescent-like opening 26.

It will be understood from FIG. 7 that the first feature, involving the presence of the protuberant portion 12, is received as depicted, for example, by the left wall member 22 and is thereby retained by the dispenser once the lower edge of portion 12 rests against the lower edge of opening 26.

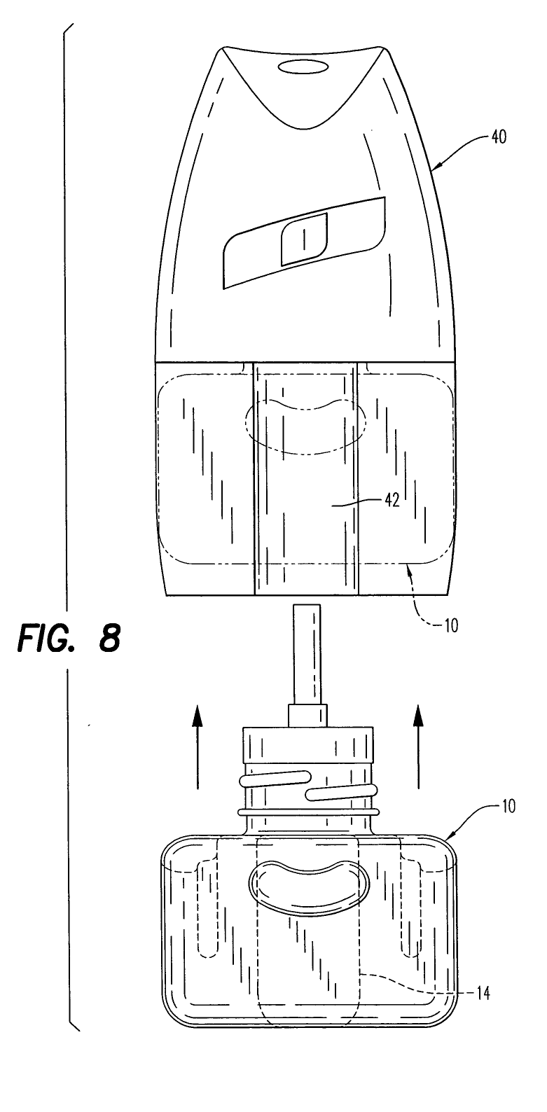

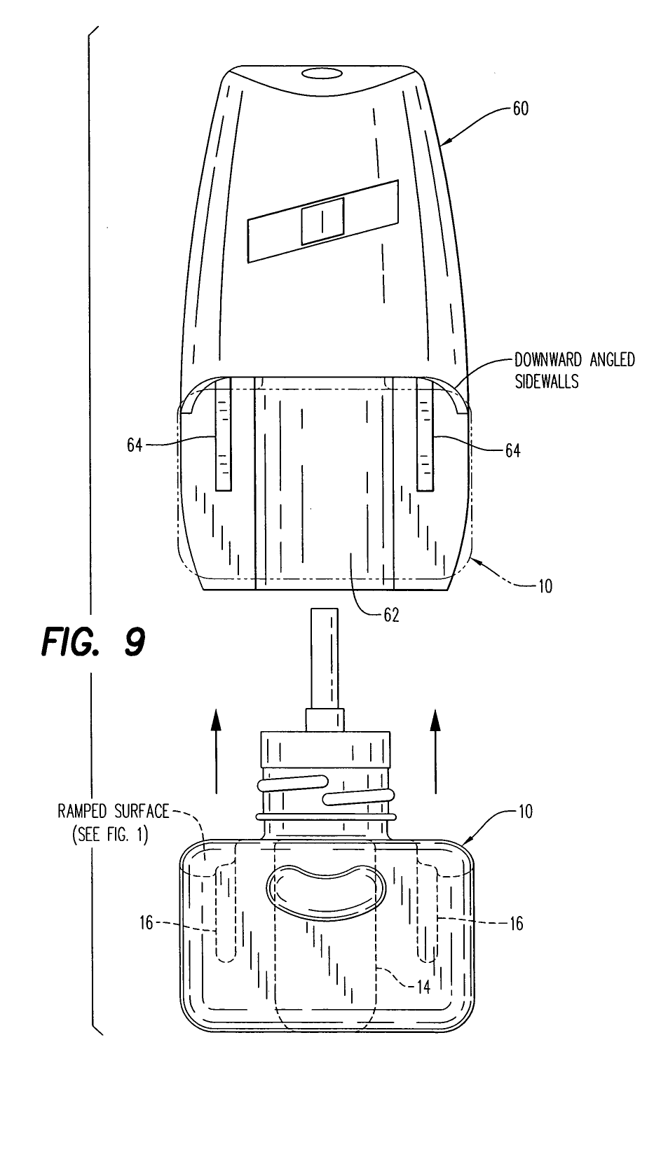

Turning now to FIG. 8, another style of dispenser 40 is depicted and the appropriately constructed second feature of the present invention is seen herein, and also in FIG. 9. Thus, there is a centrally located cylindrical protuberance or bump-out 14 on the rear surface of bottle 10, positioned so that it fits within an arcuate groove 42 provided in the dispenser so that the bottle 10 can be pushed up for proper engagement by an internal mechanism.

With reference now to a third style or configuration of dispenser 60, as depicted in FIG. 9, it will be appreciated that this dispenser 60 has in addition to an arcuate groove 62 two spaced upstanding barriers or walls 64. In this connection, the third feature is effective, namely the spaced grooves 16 on the rear wall of the bottle 10 are so formed and spaced that when the bottle 10 is inserted the grooves 16 span the barriers or walls 64, whereby the bottle can be pushed up and be held by the dispenser.

The invention having been thus described with particular reference to the preferred forms thereof, it will be obvious that various changes and modifications may be made therein without departing from the spirit and scope of the invention as defined in the appended claims.

1. A fragrance oil refill container adapted to attach selectively to each of a plurality of fragrance dispensers comprising:
protuberant means on one side of the container for fitting into an opening in one of the extending lower wall portions of a first configured dispenser, thereby selectively enabling secure attachment of the container to the first dispenser;
cylindrical means located on the opposite side of the container for fitting into an arcuate groove portion of a second, differently configured dispenser, thereby selectively enabling secure attachment of the container to the second dispenser.

2. A fragrance oil refill container, as defined in claim 1, in which spaced groove are provided on the opposite side of the container for spanning correspondingly spaced walls in a third, differently configured dispenser, thereby selectively enabling secure attachment of the container to the third dispenser.

3. A fragrance oil refill container as defined in claim 2 in which said cylindrical means is centrally located on the opposite side of the container and including a tapered portion.
